(19) United States
(12) Patent Application Publication
(10) Pub. No.: US 2008/0205242 A1
(43) Pub. Date: Aug. 28, 2008

(54) Multi-Radiation Beam Optical Scanning Device

(75) Inventors: Bernardus Hendrikus Wilhelmus Hendriks, Eindhoven (NL); Sjoerd Stallinga, Eindhoven (NL); Stein Kuiper, Eindhoven (NL); Teunis Willem Tukker, Eindhoven (NL); Coen Theodorus Hubertus Fransiscus Liedenbaum, Eindhoven (NL); Albert Hendrik Jan Immink, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/913,318

(22) PCT Filed: Apr. 26, 2006
(86) PCT No.: PCT/IB2006/051299

§ 371 Date: Nov. 1, 2007

(30) Foreign Application Priority Data
May 3, 2005 (EP) 05103675.4

(51) Int. Cl. G11B 7/135

(52) U.S. Cl. 369/112.02

(57) ABSTRACT

An optical scanning device (1) for scanning an information layer (2) of an optical record carrier (3). The device includes a radiation source (7) for providing at least a first radiation beam along a first optical path, and a second radiation beam along a second, different optical path. An objective lens system (8) converges the radiation beams on the information layer A beam-deflecting element (30) is arranged to refract said second radiation beam towards the optical axis of the lens system. The beam-deflecting element includes at least one fluid (A). A controller is provided to vary the configuration of the fluid to control the amount of refraction provided by the beam deflector element over a predetermined range.

The present invention relates to an optical scanning device utilizing at least two radiation beams, and to methods of manufacture and operation of such devices. Particular embodiments of the present invention are suitable for use in optical scanning devices compatible with two or more different formats of optical record carrier, such as compact discs (CDs), conventional digital versatile discs (DVDs), and so-called next generation DVDs, such as Blu-ray Disc (BD).

Optical record carriers exist in a variety of different formats, with each format generally being designed to be scanned by a radiation beam of a particular wavelength. For example, CDs are available, inter alia, as CD-A (CD-audio), CD-ROM (CD-read only memory) and CD-R (CD-recordable), and are designed to be scanned by means of a radiation beam having a wavelength (λ) of around 785 nm. DVDs, on the other hand, are designed to be scanned by means of a radiation beam having a wavelength of about 650 nm, and Blu-ray Discs are designed to be scanned by means of a radiation beam having a wavelength of about 405 nm. Generally, the shorter the wavelength, the greater the corresponding capacity of the optical disc e.g. a Blu-ray Disc-format disc has a greater storage capacity than a DVD-format disc.

It is desirable for an optical scanning device to be compatible with different formats of optical record carriers, e.g. for scanning optical record carriers of different formats responding to radiation beams having different wavelengths whilst preferably using one objective lens system. For instance, when a new optical record carrier with higher storage capacity is introduced, it is desirable for the corresponding new optical scanning device used to read and/or write information to the new optical record carrier to be backward compatible i.e. to be able to scan optical record carriers having existing formats.

Unfortunately, optical discs designed for being read out at a certain wavelength are not always readable at another wavelength. For example, in a CD-R-format disc, special dyes have to be applied in the recording stack in order to obtain a high modulation of the scanning beam at λ=785 nm. At λ=660 nm, the modulation signal from the disc becomes so small (due to the wavelength sensitivity of the dye) that readout at this wavelength is not feasible.

In order to allow compatibility between the different formats, optical scanning device must incorporate radiation sources arranged to provide radiation beams at each of the relevant wavelengths. A separate, discrete radiation source can be utilized for each wavelength. Alternatively, multi-wavelength radiation source (e.g. dual wavelength lasers) can be utilized. Both approaches typically result in different radiation beams being output from different positions and/or at different angles i.e. the different radiation beams are not output along a single, common optical path.

For example, in multi-laser single chip radiation sources, the individual lasers are typically separated by a distance of around 100 micron in the radial scanning direction (relative to the scanning direction of the optical disc). Consequently, the optical axes of the different lasers do not coincide, thus making it difficult to use a single detector to detect all of the radiation beams reflected from the optical record carrier. Furthermore, one or more of the beams will enter the objective lens system obliquely, resulting in coma, and thus reducing the tolerance of the system to alignment errors.

One solution to this problem is to utilize a diffraction grating to attempt to align the optical paths of two radiation beams emitted from two different emission points. US 2002/01142527 describes an optical pickup device incorporating such a diffraction element. The diffraction element is a step-like diffraction element. The step size is selected such that a first radiation beam will travel through the diffraction element without being diffracted, whilst a second, different wavelength radiation beam will be diffracted by the diffraction element.

Diffraction elements can be relatively lossy. However, for optical scanning devices using three or more different wavelength radiation beams, designing a suitable diffraction grating having both a high efficiency of transmission of incident radiation and ample positioning tolerance (to allow for manufacturing tolerances) is problematic.

U.S. Pat. No. 5,278,813 describes the use of a wedge-shaped prism. The prism is rotatable, so as to provide a shift in the position of the light spot on the optical disc. The prism is rotated so as to ensure that the light spot from a second light beam is incident at the same position on the disc as a light spot from a first light beam. The disadvantage of such a system is that it utilizes mechanical movement of the prism. The utilization of beam-deflecting devices that require mechanical movement is undesirable, as such devices are prone to mechanical fatigue and/or susceptible to vibration.

It is an aim of embodiments of the present invention to provide a multi-radiation beam optical scanning device that addresses one or more of the problems of the prior art, whether referred to herein or otherwise. It is an aim of particular embodiments of the present invention to provide an improved optical scanning device utilizing at least three different radiation beams.

According to a first aspect of the present invention there is provided an optical scanning device for scanning an information layer of an optical record carrier, the device comprising: a radiation source for providing at least a first radiation beam along a first optical path, and a second radiation beam along a second, different optical path; an objective lens system, having an optical axis, for converging said radiation beams on said information layer; and a beam-deflecting element arranged to refract at least said second radiation beam towards the optical axis, wherein the beam-deflecting element comprises at least one fluid and a controller for varying the configuration of said fluid to controllably vary the amount of refraction provided by the beam-deflector element over a predetermined range.

Advantageously, such a device utilizes a fluid to define a refractive interface, boundary or surface. The degree of refraction provided by the deflector element is thus dependent upon on the configuration (e.g. orientation or shape) of the fluid. The degree of refraction is the amount of refraction (change in direction of propagation of the wavefront) that will be provided to a radiation beam incident on the interface along a predetermined direction. The degree of refraction can be changed by altering at least one of: the refractive index of one of the materials defining the interface, or the angle of the interface relative to the predetermined direction.

Consequently, as no movement of rigid objects is required (i.e. no mechanical movement) such a beam-deflecting element need not be susceptible to mechanical fatigue. Moreover, by appropriate variation of the degree of refraction provided by the deflecting element, it is possible to utilize the deflecting element to substantially align the optical paths of a plurality of radiation beams along the optical axis. Said fluid may comprise a birefringent material and the controller is arranged to alter the orientation of the birefringent material.

Preferably, said birefringent material comprises a liquid crystal, and the controller is arranged to provide an electric field across the liquid crystal for altering the orientation of the liquid crystal.

Said element may comprise a chamber, and said at least one fluid may comprise a first, polar fluid and a second, insulative fluid, the two fluids being non-miscible and separated along an interface, and the controller being arranged to alter the configuration of the interface via the electrowetting effect.

The controller may be arranged to alter the shape of the interface.

The controller may be arranged to alter the angle of the interface relative to the optical axis.

The interface may be substantially planar.

Preferably, the controller is arranged to alter the refraction provided by the beam-deflecting element in dependence upon a signal indicative of which radiation beam is being provided by said radiation source.

Preferably, there is provided a detector for detecting at least a portion of the radiation beams reflected from the optical record carrier, and wherein the controller is arranged to alter the refraction provided by the beam-deflecting element in dependence upon the signal detected by said detector.

Preferably, the device comprises a detector for detecting at least a portion of the radiation beams reflected from the optical record carrier; and a beam splitter for transmitting incident radiation beams received from the radiation source towards the optical record carrier, and for transmitting beams reflected from the optical record carrier towards the detector; and wherein the beam-deflecting element is positioned between the radiation source and the beam splitter.

Preferably, the device further comprises an astigmatism correction plate arranged to cancel out astigmatism introduced into the beam by the beam-deflecting element.

The beam-deflecting element may be arranged to further refract the second radiation beam so as to direct the optical path of the second radiation beam along the optical axis.

Preferably, the radiation source is arranged to provide a third radiation beam along a third optical path different from said first and second optical paths, the beam-deflecting element being further suitable for refracting said third radiation beam towards the optical axis.

According to a second aspect of the present invention there is provided a method of manufacture of an optical scanning device for scanning an information layer of an optical record carrier, comprising: providing a radiation source for providing at least a first radiation beam along a first optical path, and a second radiation beam along a second, different optical path; providing an objective lens system, having an optical axis, for converging said radiation beams on said information layer; and providing a beam-deflecting element arranged to refract at least said second radiation beam towards the optical axis, wherein the beam-deflecting element comprises at least one fluid and a controller for varying the configuration of said fluid to controllably vary the amount of refraction provided by the beam-deflector element over a predetermined range.

According to a third aspect of the present invention there is provided a method of operation of an optical scanning device for scanning an information layer of an optical record carrier, the device comprising a radiation source for providing at least a first radiation beam along a first optical path, and a second radiation beam along a second, different optical path, an objective lens system, having an optical axis, for converging said radiation beams on said information layer, and a beam-deflecting element arranged to refract at least said second radiation beam towards the optical axis, wherein the beam-deflecting element comprises at least one fluid and a controller for varying the configuration of said fluid to controllably vary the amount of refraction provided by the beam-deflector element; wherein the method of operation comprises varying the refraction provided by the beam-deflecting element over a predetermined range in dependence upon the radiation beam being provided by the radiation source.

Preferred embodiments will now be described, by way of example only, with reference to the accompanying drawings, in which:

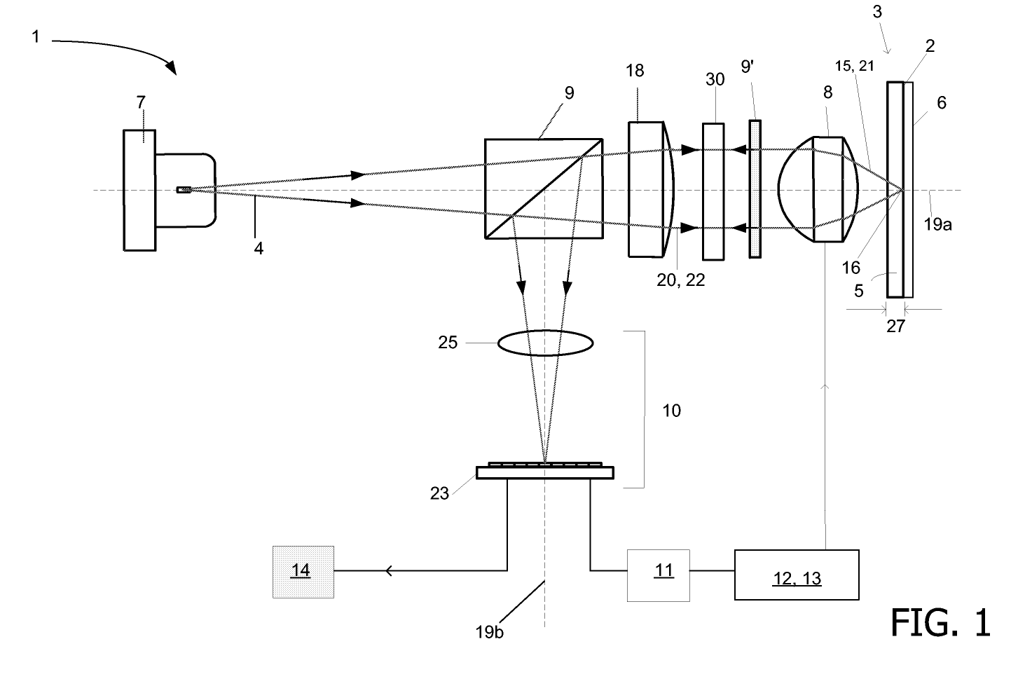

FIG. 1 is a schematic diagram of an optical scanning device according to an embodiment of the present invention;

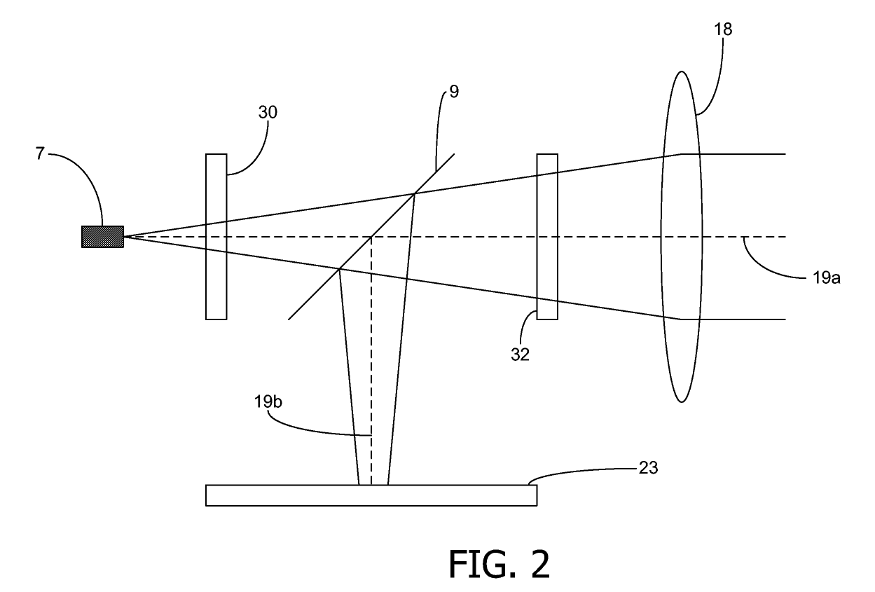

FIG. 2 is a schematic diagram of a portion of an optical scanning device according to an alternative embodiment of the present invention;

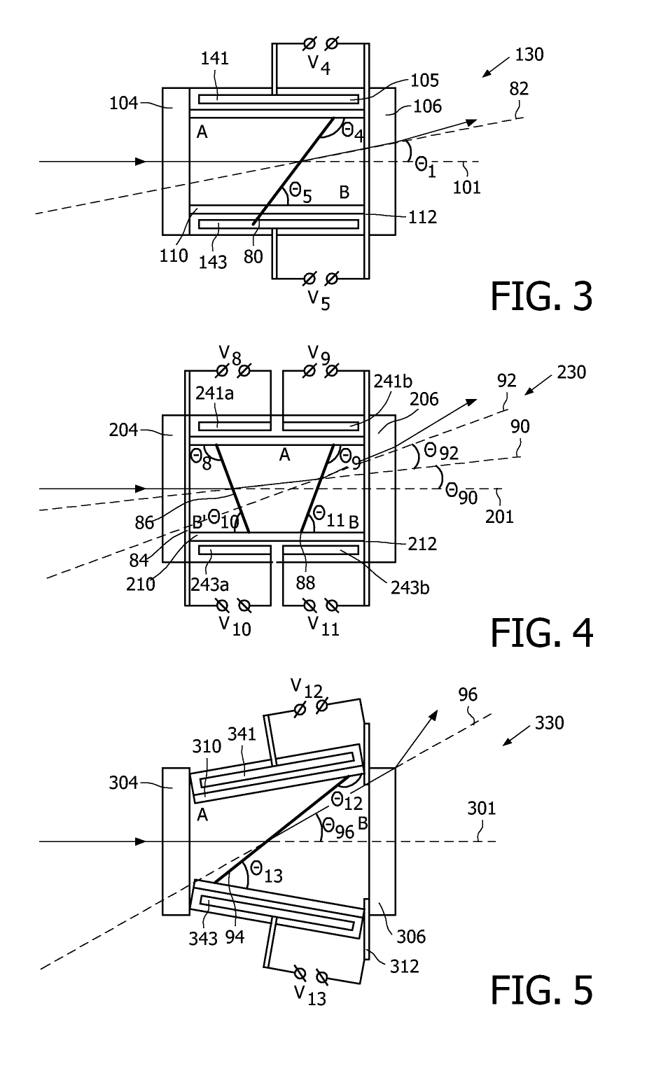

FIGS. 3, 4 and 5 each show a simplified side view cross-section of a beam-deflecting element incorporating a meniscus apparatus for refractive beam deflection, suitable for use in the optical scanning devices of FIGS. 1 and 2;

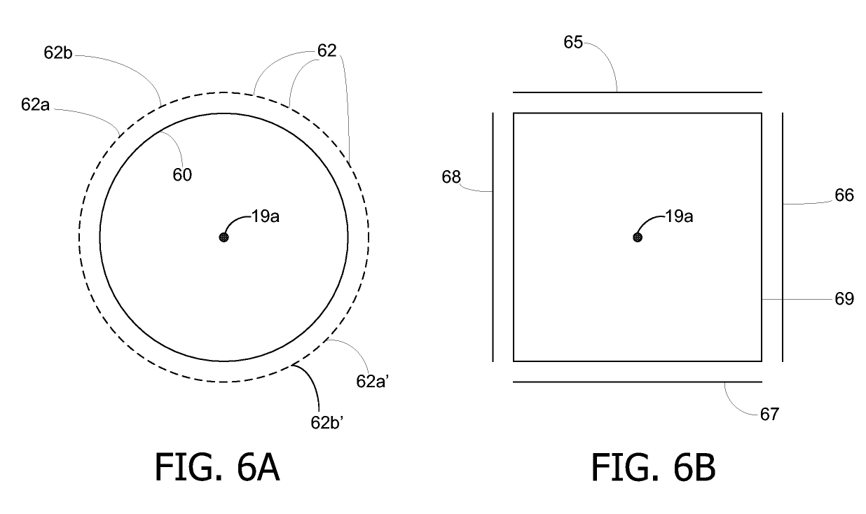

FIGS. 6A and 6B show top view cross-sections of alternative electrode configurations for use in any of the beam-deflecting elements shown in FIGS. 3 to 5;

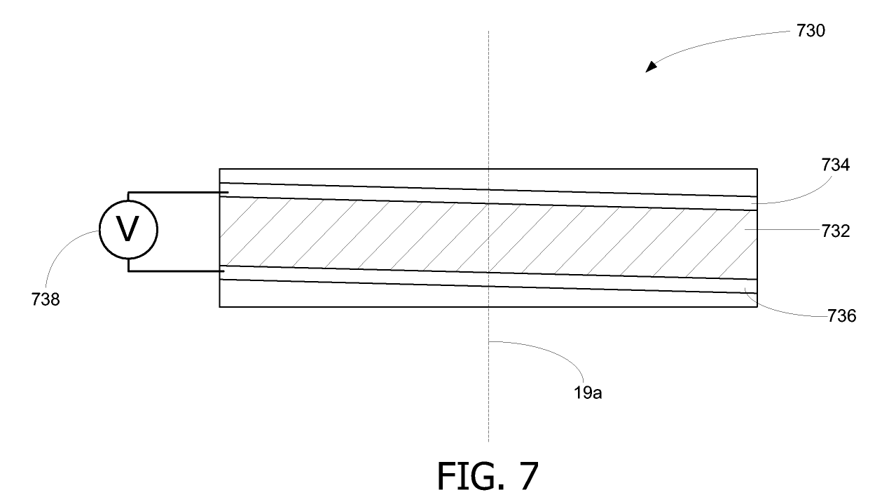

FIG. 7 shows a simplified side cross-sectional view of a liquid crystal based beam-deflecting element suitable for use in the devices shown in FIGS. 1 and 2;

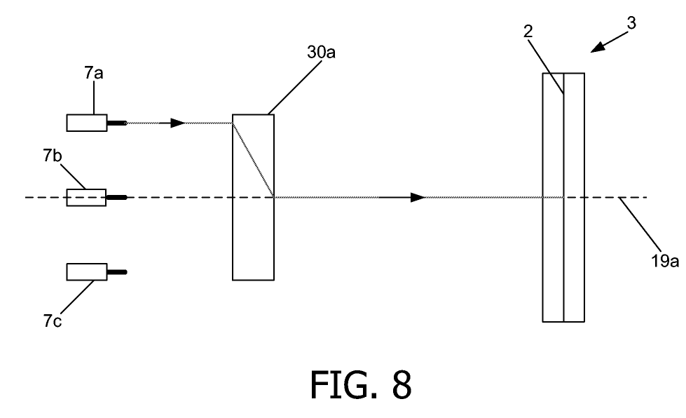

FIG. 8 shows one mode of operation of a beam-deflecting element in a scanning device.

The present inventors have realized that instead of utilizing a rigid diffraction grating or a rigid refractive element to alter the paths of beams of radiation, a refractive element can be utilized that is capable of flow e.g. it is a fluid. By altering the configuration of the fluid (e.g. the shape of the fluid body or the orientation of the molecules within the fluid) over a predetermined range, the degree of refraction provided by the element to an incident radiation beam can be similarly controllably varied. Typically an electrically susceptible fluid is utilized, and a controller comprising electrodes is arranged to provide an electric field, for altering the configuration of the fluid.

Consequently, such a beam deflector element, incorporating a fluid, can be controlled to optimize the alignment of the radiation paths of the beams emitted from the radiation source(s), by changing the amount of refraction provided by the beam-deflecting element for different radiation beams e.g. allowing the element to be utilized with optical scanning devices utilizing three or more different radiation beams.

An optical scanning device including such a beam-deflecting element will now be described in more detail, and then subsequently further details of the beam-deflecting element described.

FIG. 1 shows a device 1 for scanning a first information layer 2 of a first optical record carrier 3 by means of a first radiation beam 4, the device including an objective lens system 8.

The optical record carrier 3 comprises a transparent layer 5, on one side of which information layer 2 is arranged. The side of the information layer 2 facing away from the transparent layer 5 is protected from environmental influences by a protective layer 6. The side of the transparent layer facing the device is called the entrance face. The transparent layer 5 acts as a substrate for the optical record carrier 3 by providing mechanical support for the information layer 2. Alternatively, the transparent layer 5 may have the sole function of protecting the information layer, while the mechanical support is provided by a layer on the other side of the information layer 2, for instance by the protective layer 6 or by an additional information layer and transparent layer connected to the uppermost information layer. It is noted that the information layer has first information layer depth 27 that corresponds, in this embodiment as shown in FIG. 1, to the thickness of the transparent layer 5. The information layer 2 is a surface of the carrier 3.

Information is stored on the information layer 2 of the record carrier in the form of optically detectable marks arranged in substantially parallel, concentric or spiral tracks, not indicated in the Figure. A track is a path that may be followed by the spot of a focused radiation beam. The marks may be in any optically readable form, e.g. in the form of pits, or areas with a reflection coefficient, or a direction of magnetization different from the surroundings, or a combination of these forms. In the case where the optical record carrier 3 has the shape of a disc.

As shown in FIG. 1, the optical scanning device 1 includes a radiation source 7, a collimator lens 18, a beam splitter 9, an objective lens system 8 having an optical axis 19a, a diffractive part 24, and a detection system 10. Furthermore, the optical scanning device 1 includes a servo circuit 11, a focus actuator 12, a radial actuator 13, and an information-processing unit 14 for error correction.

In this particular embodiment, the radiation source 7 is arranged for consecutively or separately supplying a first radiation beam 4, a second radiation beam 4′ and a third radiation beam 4″. For example, the radiation source 7 may comprise a tunable semiconductor laser for consecutively supplying two of the radiation beams 4, 4′and 4″ with a separate laser supplying the third beam, or three semiconductor lasers for separately supplying these radiation beams. The output paths of at least two of the radiation beams 4, 4′ and 4″ are different. For instance, two or more of the radiation beams may be emitted from different physical positions of the radiation source 7 and/or at different angles relative to the optical axis 19a of the objective lens system. Typically, each radiation beam is divergent. Typically, each of the radiation beams will be emitted along parallel optical axis, with the beams being emitted from different positions. For instance, the optical axis of the radiation beams may be parallel, and 100 microns apart, due to the emission points of the radiation beams from the radiation source 7 being 100 microns apart. This separation of the radiation beam paths is normally in the radial scanning direction (relative to the direction scanned by the beam on the optical record carrier).

The radiation beam 4 has a wavelength λ₁ and a polarization p₁, the radiation beam 4′ has a wavelength λ₂ and a polarization p₂, and the radiation beam 4″ has a wavelength λ₃ and a polarization p₃. The wavelengths λ₁, λ₂, and λ₃ are all different. Preferably, the difference between any two wavelengths is equal to, or higher than, 20 nm, and more preferably 50 nm. Two or more of the polarizations p₁, p₂, and p₃ may differ from each other.

The collimator lens 18 is arranged on the optical axis 19a for transforming the divergent radiation beam 4 into a substantially collimated beam 20. Similarly, it transforms the radiation beams 4′ and 4″ into two respective substantially collimated beams 20′ and 20″ (not shown in FIG. 1).

The beam splitter 9 is arranged for transmitting the radiation beams towards the objective lens system 8. In the example shown, the radiation beams are transmitted towards the objective lens system 8 via transmission through the beam splitter 9. Preferably, the beam splitter 9 is formed with a plane parallel plate that is tilted at an angle α with respect to the optical axis, and more preferably α=45°. In this particular embodiment the optical axis 19a of the objective lens system 8 is common with an optical axis of the radiation source 7.

A beam-deflecting element 30 is located on the optical axis 19a. In this particular embodiment, the beam-deflecting element 30 is positioned between the collimator lens 18 and the objective lens system 8.

Each of the radiation beams is transmitted through the beam deflection element 30. Further, the beam-deflecting element 30 is arranged to direct each of the radiation beams towards the optical axis 19a of the objective lens system 8. In this particular embodiment, the optical axis 19a is common with an optical axis of the radiation source 7 i.e. at least one of the radiation beams has an optical path along the optical axis 19a. Any such radiation beams, that are already aligned with the optical axis 19a, are transmitted without refraction by the beam-deflecting element 30. Any of the radiation beams that are not aligned with the optical axis 19a are directed towards the optical axis 19a by the beam-deflecting element 30. Preferably, the beam-deflecting element 30 is arranged to refract each of the non-aligned beams, so as to align with the optical axes i.e. such that each beam path is along the optical axis 19a.

Aligning each of the radiation beams with the optical axis 19a will generally require two refractive interfaces. The first refractive interface will refract the radiation beam in the direction of the optical axis 19a i.e. such that it is at an angle heading towards the optical axis 19a. The second refractive interface will then refract the optical path of the radiation beam again, so as to be along the optical axis 19a.

The objective lens system 8 is arranged for transforming the collimated radiation beam 20 to a first focused radiation beam 15 so as to form a first scanning spot 16 in the position of the information layer 2.

During scanning, the record carrier 3 rotates on a spindle (not shown in FIG. 1), and the information layer 2 is then scanned through the transparent layer 5. The focused radiation beam 15 reflects on the information layer 2, thereby forming a reflected beam 21 which returns on the optical path of the forward converging beam 15. The objective lens system 8 transforms the reflected radiation beam 21 to a reflected collimated radiation beam 22. The beam splitter 9 separates the forward radiation beam 20 from the reflected radiation beam 22 by transmitting at least part of the reflected radiation 22 towards the detection system 10. In the illustrated example, the reflected radiation beam 22 is transmitted towards the detection system 10 by reflection from a plate within beam splitter 9. In the particular embodiment shown, the beam splitter 9 is a polarizing beam splitter. A quarter waveplate 9′ is positioned along the optical axis 19 between the beam splitter 9 and the objective lens system 8. The combination of the quarter waveplate 9′ and the polarizing beam splitter 9 ensures that the majority of the reflected radiation beam 22 is transmitted towards the detection system 10 along detection system optical axis 19b.

The detection system 10 includes a convergent lens 25 and a detector 23, which are arranged for capturing said part of the reflected radiation beam 22.

The detector is arranged to convert said part of the reflected beam to one or more electrical signals.

One of the signals is an information signal, the value of which represents the information scanned on the information layer 2. The information signal is processed by the information processing unit 14 for error correction.

Other signals from the detection system 10 are a focus error signal and a radial tracking error signal. The focus error signal represents the axial difference in height along the Z-axis between the scanning spot 16 and the position of the information layer 2. Preferably, this signal is formed by the “astigmatic method” which is known from, inter alia, the book by G. Bouwhuis, J. Braat, A. Huijiser et al, “Principles of Optical Disc Systems”, pp. 75-80 (Adam Hilger 1985, ISBN 0-85274-785-3). The radial tracking error signal represents the distance in the XY-plane of the information layer 2 between the scanning spot 16 and the center of track in the information layer 2 to be followed by the scanning spot 16. This signal can be formed from the “radial push-pull method” which is also known from the aforesaid book by G. Bouwhuis, pp. 70-73.

The servo circuit 11 is arranged for, in response to the focus and radial tracking error signals, providing servo control signals for controlling the focus actuator 12 and the radial actuator 13 respectively. The focus actuator 12 controls the position of the objective lens 8 along the Z-axis, thereby controlling the position of the scanning spot 16 such that it coincides substantially with the plane of the information layer 2. The radial actuator 13 controls the radial position of the scanning spot 16 so that it coincides substantially with the center line of the track to be followed in the information layer 2 by altering the position of the objective lens 8.

The objective lens 8 is arranged for transforming the collimated radiation beam 20 to the focus radiation beam 15, having a first numerical aperture NA₁, so as to form the scanning spot 16. In other words, the optical scanning device 1 is capable of scanning the first information layer 2 by means of the radiation beam 15 having the wavelength λ₁, the polarization p₁ and the numerical aperture NA₁.

Furthermore, the optical scanning device in this embodiment is also capable of scanning a second information layer 2′ of a second optical record carrier 3′ by means of the radiation beam 4′, and a third information layer 2″ of a third optical record carrier 3″ by means of the radiation beam 4″. Thus, the objective lens system 8 transforms the collimated radiation beam 20′ to a second focused radiation beam 15′, having a second numerical aperture NA₂ so as to form a second scanning spot 16′ in the position of the information layer 2′. The objective lens 8 also transforms the collimated radiation beam 20″ to a third focused radiation beam 15″, having a third numerical aperture NA₃ so as to form a third scanning spot 16″ in the position of the information layer 2″.

Any one or more of the scanning spots 16, 16′, 16″ may be formed with two additional spots for use in providing an error signal. These associated additional spots can be formed by providing an appropriate diffractive element in the path of the optical beam 20.

Similarly to the optical record carrier 3, the optical record carrier 3′ includes a second transparent layer 5′ on one side of which the information layer 2′ is arranged with the second information layer depth 27′, and the optical record carrier 3″ includes a third transparent layer 5″ on one side of which the information layer 2″ is arranged with the third information layer depth 27″.

In this embodiment, the optical record carrier 3, 3′ and 3″ are, by way of example only, a “Blu-ray Disc”-format disc, a DVD-format disc and a CD-format disc, respectively. Thus, the wavelength λ₁ is comprised in the range between 365 and 445 nm, and preferably, is 405 nm. The numerical aperture NA₁ equals about 0.85 in both the reading mode and the writing mode. The wavelength λ₂ is comprised in the range between 620 and 700 nm, and preferably, is 650 nm. The numerical aperture NA₂ equals about 0.6 in the reading mode and is above 0.6, preferably 0.65, in the writing mode. The wavelength λ₃ is comprised in the range between 740 and 820 nm and, preferably is about 785 nm. The numerical aperture NA₃ is below 0.5, and is preferably 0.45 for the reading of information from CD-format discs, and preferably between 0.5 and 0.55 for writing information to CD-format discs.

FIG. 2 shows a simplified schematic diagram of a radiation path through a portion of a scanning device in accordance with an alternative embodiment of the present invention. The scanning device illustrated in FIG. 2 generally corresponds to that shown in FIG. 1, with identical reference numerals being utilized to illustrate similar features. In this particular embodiment, the beam-deflecting element is placed in the radiation path between the radiation source 7 and the beam splitter 9, instead of being located between the collimator 18 and the optical record carrier 3 (as shown in FIG. 1). This arrangement has the advantage that the spots incident upon the detector 23 are co-axial i.e. the spots are not displaced with respect to each other. However, as the beam-deflecting element 30 is placed in the diverging beam between the radiation source 7 and the collimator 18, astigmatism may be introduced into the transmitted radiation beam. To prevent any such astigmatism affecting the resulting spot 16 incident on the information layer 2 of the optical record carrier 3, an astigmatism correction plate 32 may be added to the radiation beam path. The astigmatism correction plate 32 is placed in the radiation beam path between the beam splitter 9 and the collimator 18. The astigmatism correction plate is a transparent plate. The astigmatism correction plate 32 is arranged for correcting the transmitted radiation beam of undesirable astigmatism introduced into the beam e.g. by the beam-deflecting element 30. The plate 32 is arranged to apply the opposite astigmatism to the beam, so as to cancel out the undesirable astigmatism from the beam. For instance, the astigmatism correction plate may comprise one or more refractive interfaces, so as to provide the desired level of astigmatism to the transmitted beam for correction purposes.

By placing the astigmatism correction plate 32 between the beam splitter 9 and the collimator 18, then radiation reflected from the optical carrier 3 will only pass through this correction plate 32, and not the beam-deflecting element 30. Consequently, this reflected beam, as transmitted by the beam divider 9 towards the detector 23, will contain astigmatism. In the astigmatic method described above, typically the lens 25 shown in FIG. 1 will be used to introduce astigmatism into the transmitted beam, for ensuring the beam incident on the detector has the desired astigmatism for determining the focus error signal. In this particular embodiment, the desired amount of astigmatism is provided by the astigmatism correction plate, and hence the lens 25 can be eliminated from the optical scanning device.

The beam-deflecting element can be implemented in a variety of ways.

Preferably, the beam-deflecting element is arranged to provide a predetermined range of deflection of the incident deflected beam.

In preferred embodiments, a beam deflector will only be arranged to controllably deflect the beam in one dimension. Typically, the beam deflector will only need to alter the path of any radiation beam in one dimension, so as to align the path with the optical axis 19a. For instance, an element might only be arranged to deflect the beam paths to alter the radial position of the resulting spots on the surface of the optical record carrier. If required, the optical scanning device may include a second beam-deflecting element. This second beam-deflecting element may be orientated to provide beam deflection in an orthogonal direction to that provided by the first beam-deflecting element. Alternatively, the second beam-deflecting element may be oriented to provide beam deflection in the opposite direction to that provided by the first beam-deflecting element.

The beam-deflecting elements will normally be placed sequentially along the optical axis 19a of the objective lens system. For instance, if a first beam-deflecting element is arranged to alter the lateral position of the spot in the X direction, then the second beam-deflecting element may be arranged to alter the lateral position of the spot in the Y direction (assuming the optical axis 19a is perpendicular to the XY plane).

Alternatively, if the first beam-deflecting element is arranged towards the lateral position of the spot in the X direction, then the second beam-deflecting element may be arranged towards the lateral position of the spot in the minus X direction. Thus, the first beam-deflecting element would be arranged to direct a radiation beam path towards the optical axis 19a, with the second beam-deflecting element arranged subsequently to re-direct the radiation beam path along the optical axis 19a.

Suitable beam-deflecting elements are, for instance described within International Application No. PCT/IB2003/005325, published as WO 2004/051323, “Apparatus for forming variable fluid meniscus configurations”. Such an apparatus comprises a fluid chamber holding two different fluids (A, B) separated by an interface (a meniscus). The edge of the meniscus is constrained by the sidewalls of the fluid chamber. The two fluids are immiscible, and have different refractive indices. One of the fluids is not electrically susceptible e.g. it is a non-conducting (insulative) non-polar fluid (such as silicone oil or an alkane). The other fluid is an electrically susceptible fluid e.g. an electrically conducting polar fluid, such as an aqueous salt solution. An electrically susceptible fluid is a fluid that is affected by an electric field. Either of the fluids may be liquid, or gas, or any material subject to flow e.g. a liquid crystal. Preferably, the two fluids have a substantially equal density, so that the apparatus forming the beam-deflecting element functions independently of orientation, i.e. without dependence on gravitational effects between the two fluids. This may be achieved by appropriate selection of the first and second fluid constituents.

Electrodes positioned adjacent the walls of the chamber are used to control the contact angle of the edge of the meniscus with the chamber sidewall. The electrodes are coated with an electrically insulating layer e.g. of parylene. The chamber is typically cylindrical, extending along the optical axis of the optical element. Various embodiments of different beam-deflecting elements are illustrated in FIGS. 3, 4 and 5. In each instance, the cross-section of the cylindrical chamber may be of any desired shape, including circular (as indicated in FIG. 6A) or square (as indicated in FIG. 6B).

FIGS. 6A and 6B illustrate two alternative cross-sections of the chamber, taken perpendicular to the optical axis 19a. In FIG. 6A, the chamber has a circular internal sidewall 60. A plurality of segment electrodes are located about the optical axis 19b of the beam-deflecting element. The sidewall segment electrodes 62 are grouped in pairs, illustrated by example with labels 62a and 62a′, and 62b and 62b′ etc. Each member of a pair lies parallel to the other on the opposite side of the optical axis 19b. A voltage control circuit (not shown) is connected to the electrode configuration to apply varying voltage patterns to the segment electrodes 2. FIG. 6B shows an alternative cross-section of a chamber having sidewalls 69 defining a square. Two axially-spaced sets of electrowetting sidewall electrodes 65, 67 and 66, 68 are spaced about the perimeter of the chamber. The four rectangular segment electrodes 65, 66, 67, 68 are spaced about the optical axis 19b of the beam-deflecting element. Opposite segment electrodes 65, 67 are arranged as a pair, and electrodes 66, 68 are arranged as a pair. The longitudinal edges of each pair of electrodes is parallel.

Typically, a further electrode will be in electrical contact with the electrically susceptible (e.g. conducting) fluid contained within the chamber. Typically, this further electrode is located at an end of the chamber. Voltages are applied across the end electrode and each of the individual sidewall electrodes. The voltage applied across the end electrode and any sidewall electrode will act to define the surface contact angle of the adjacent sidewall i.e. the angle at which the meniscus contacts the adjacent portion of the sidewall. Preferably, the voltages applied to pairs of electrodes are arranged such that the contact angle provided on pairs of electrodes is equal to 180°, if the chamber walls are parallel. For example, if a voltage applied between the end electrode and electrode 62a is selected to provide a contact angle at the adjacent sidewall position of 60°, then the voltage applied between the end electrode and sidewall electrode 62a′ such as to provide a contact angle of 120° adjacent that electrode. The voltages applied to each electrode are preferably selected so as to provide a generally flat (i.e. planar) meniscus, by control of the contact angles of the meniscus. The meniscus is preferably substantially planar so as to provide a refractive interface with no optical power.

FIG. 3 shows a side view cross-section of a fluid meniscus configuration suitable for refractive light deflection i.e. for use as a beam-deflecting element in accordance with the embodiment of the present invention. Sidewall segment electrodes 141, 143 extend longitudinally along the chamber, parallel to the internal sidewall surface of the chamber containing fluids A, B. Meniscus 80 defines the interface between the two fluids A, B. An insulative layer 110 separates the two fluids from contact with the electrodes.

In this particular embodiment, the second fluid B is the electrically susceptible fluid. An electrode 112 is in electrical contact with the second fluid B. In the particular embodiment shown, the electrode 112 extends continuously over one end of the chamber. In such an instance, the electrode will be transparent e.g. formed from ITO (Indium Tin Oxide). The chamber also has transparent end walls 104, 106.

A voltage V₄ is applied across the end wall electrode 112 and the sidewall electrode 141, resulting in the fluid contact angle θ₄ (e.g. 60°) between the liquid A and the fluid contact layer 110. The fluid contact angle is the angle made by the edge of the meniscus 80 with the adjacent sidewall. Similarly, a voltage V₅ is applied across the end wall electrode 112 and the sidewall electrode 143, resulting in a fluid contact angle θ₅. In this particular embodiment, voltages V₄ and V₅ are selected such that the sum of the contact angles θ₄ and θ₅ equals 180°. This results in a flat fluid meniscus 80 between the liquids A and B, at least in the dimension illustrated within the Figure.

An incoming light beam with a first optical axis 101 is deflected in the relevant dimension, in a direction perpendicular to the sidewall electrodes 141 and 143, by the flat fluid meniscus 80, to produce an exiting light beam with a second optical axis 82, at an angle θ₁ relative to the first optical axis 101. The incoming light is represented by arrows within the FIG. 3. It will be seen that the total deflection of the beam-deflecting element 130 is, in this instance, greater than θ₁ due to the slight refraction of the light beam as it exits end surface 106.

The deflection angle θ₁ can be varied by variation of the applied electrode voltages V₄, V₅. Preferably, the sum of the contact angles θ₄ and θ₅ is maintained at 180°, so as to provide a flat meniscus in the dimension shown.

By swapping the applied voltages V₄ and V₅ with each other, a negative deflection angle of θ₁ is obtained between the second optical axis 82 from the first optical axis 101 in the same angular plane. Thus, by varying the magnitudes of voltages V₄ and V₅, the deflection of the light beam incident to the beam-deflecting element 130 can be controllably varied over a continuous range of deflection angles.

Preferably, the cross-section of the beam-deflecting element 130 illustrated in FIG. 3 is similar to that illustrated in FIG. 6B. For instance, electrodes 141, 143 could correspond to electrodes 65, 67 respectively. Another pair of electrodes (not shown, but numbered 142 and 144 for convenience) would then correspond to electrodes 66, 68 respectively. This second electrode pair 142, 144, when viewed cross-sectionally, is positioned perpendicular to the first electrode pair 141, 143. In a similar manner to voltages V₄ and V₅ being applied to electrodes 141 and 143 to provide contact angles θ₄ and θ₅, voltages V₆ and V₇ would be applied respectively to electrodes 142 and 144 to define respective clear contact angles θ₆ and θ₇. Preferably, θ₆ and θ₇ sum to 180°. If voltages V₆ and V₇ are selected such that the fluid contact angles θ₆ and θ₇ are each 90°, then this will result in a flat fluid meniscus 80 between the liquids A and B. In other words, by ensuring that fluid contact angles θ₆ and θ₇ are each 90°, and that the sum of fluid contact angles θ₄ and θ₅ is 180°, then a one dimensional deflection of the light beam incident upon the beam-deflecting element 130 will be achieved.

A further one dimensional deflection of an incoming light beam in a plane perpendicular to that of the deflection angle θ₁ is achieved by controlling the applied voltages V₆ and V₇ across the end wall electrode 112 and sidewall electrodes 142 or 144 respectively, such that the sum of the corresponding fluid contact angles θ₆ and θ₇ also equals 180°. By variation of the applied electrode voltages V₆, V₇, whilst maintaining the sum of θ₆ and θ₇ equal to 180°, an incoming beam of light with first optical axis 101 can be deflected by a second deflection angle θ₂ (not shown), lying in a plane perpendicular to the deflection angle θ₁. Thus, two dimensional control of the deflection of a light beam can be achieved, allowing control of the spot position on the detector 23 in both X and Y directions.

FIG. 4 shows a side view cross-section of a beam-deflecting element 230 incorporating a fluid meniscus configuration suitable for refractive light deflection in accordance with a further embodiment of the present invention. In the configuration illustrated, a greater angle of total deflection can be achieved than that of the embodiment shown in FIG. 3 (assuming the same fluids are utilized). Features of this embodiment are similar to those described in relation to FIG. 3, but incremented by 100 (e.g. end wall 204 corresponds to end wall 104 in FIG. 3). In this embodiment a second end wall electrode 84 is provided, which is annular in shape and adjacent the front wall 204 (as compared to the first end wall electrode 212, which is annular in shape, and adjacent the back wall 206). This second end wall electrode is arranged with at least one part in the fluid chamber such that the electrodes acts upon a second fluid layer of fluid B, labeled B′ in FIG. 4. The second layer of fluid B (fluid B′) is separated from the layer of liquid A by a first fluid meniscus 86. A second fluid meniscus 88 separates fluid layers A and B. In this particular embodiment, the fluid B′ comprises the same fluid as fluid B as described in the previous embodiment. However, it should be noted that fluid B′ may be any alternative fluid which is non-miscible with fluid A, electrically susceptible, and preferably of a substantially equal density to fluids A and B.

In this embodiment, two axially-spaced sets of electrowetting electrodes are spaced at the perimeter of the sidewall. Preferably the electrodes are arranged similar to electrodes 65, 67 in FIG. 6B. One set of electrodes includes electrodes 241a, 243a. The other set includes electrodes 241b, 243b. Variation of the applied voltages V₈ and V₁₀ applied across the second end wall electrode 84 and sidewall electrodes 241 and 243 respectively, cause the corresponding fluid contact angles θ₈ and θ₁₀ to vary. The first fluid meniscus 86 is flat when the sum of the fluid contact angles θ₈ and θ₁₀ equals 180°. Similarly, the shape of the second fluid meniscus 88 can be varied by variation of the applied voltages V₉ and V₁₁ across the first end wall electrode 206 and sidewall electrodes 241 and 243 respectively. The second meniscus 88 is flat when the sum of the fluid contact angles θ₉ and θ₁₁ equals 180° with the applied voltages V₉ and V₁₁.

An incoming light beam along the first optical axis 201 is deflected one dimensionally in the plane of sidewall electrodes 241, 243 by the flat first fluid meniscus 86. The deflected light beam has a second optical axis 90, and is angularly related to the first optical axis 201 by a deflection axis θ₉₀. The deflected light beam with the second optical axis 90 is further deflected by the flat second fluid meniscus 88. The resultant further deflected light beam has a third optical axis 92 which is angularly related to the second optical axis 90 by the deflection angle θ₉₂. The sum of deflection angles θ₉₀ and θ₉₂ gives the combined deflection angle of the incoming light beam due to the interfaces between the fluids. As detailed in relation to previous embodiments, by further applying voltages across each end wall electrodes 204, 206 and each sidewall electrode 242, 244 (not shown) respectively, lying perpendicular to sidewall electrodes 241, 243, the flat menisci 86 and 88 can be controlled to deflect an incoming light beam in a further angular plane perpendicular to that of deflection angles θ₉₀, θ₉₂, and hence deflect an incoming light beam in two dimensions.

By swapping applied voltages across the sidewall electrode pairs with each other, negative values of the deflection angles θ₉₀, θ₉₂ can be achieved. If desired, as in other embodiments, the electrowetting electrodes of this embodiment may be rotated about the optical axis 201 either electrically, or by using a provided rotation mechanism (e.g. mechanical actuator) to achieve correct angular positioning of the fluid menisci.

In a preferred embodiment, the first meniscus 86 is arranged to refract a first radiation beam traveling on one side of an optical axis e.g. parallel to the axis), towards the optical axis. The angle of refraction, and the separation of the refractive surfaces (i.e. menisci 86, 88) are selected such that the radiation beam will be incident upon the second refractive surface at the point at which the surface (meniscus 88) crosses the optical axis. The second refractive surface (meniscus 88) is then arranged to refract the radiation beam such that the optical path of the beam is along the optical axis. Preferably, the beam-deflecting element is arranged such that the deflection angles can be reversed i.e. swapped from positive to negative (or vice versa), such that the beam-deflecting element can be arranged to similarly deflect the path of a further radiation beam, traveling along the other side of the optical axis (distance from the first beam, but in the same plane), such that the further beam is aligned along the optical axis. If the optical scanning device incorporating such a beam-deflecting element utilizes three different beams of radiation, then preferably the other (e.g. third) beam of radiation is incident upon the beam-deflecting element along the optical axis, with the element being configurable to not refract the path of the beam e.g. to alter the menisci to provide no refraction by altering the plane of the menisci to be perpendicular to the beam. Alternatively, this other beam may also be provided along an optical path that is not aligned with the optical axis, with the beam deflector being operable to deflect the path of this other optical beam to align with the optical axis of the optical scanning device.

In a further envisaged embodiment, the two flat fluid menisci 86, 88 are arranged to lie parallel to each other, using only a single set of electrodes spaced about the perimeter of the chamber.

FIG. 5 shows a side cross-section view of a further embodiment of a beam-deflecting element 330 using a fluid meniscus configuration suitable for refractive light deflection. In the embodiments described with respect to FIGS. 3 and 4, the total deflection achievable by the fluid menisci is limited by the difference in refractive index between adjacent fluids, and the range of fluid contacts angles feasible due to the intrinsic nature of the fluids. This embodiment enables a greater total deflection angle to be achieved, than could otherwise be realized. Similar features are shown by using similar reference numerals, but with the reference numerals incremented by 100 compared to FIG. 4 and 200 compared to FIG. 3 (i.e. end surface 104, 204 from FIGS. 3 and 4 is now labeled 304). In this embodiment, the pair of sidewall electrodes 341, 343 do not lie parallel to each other. The same applies to the perpendicular pair of sidewall electrodes 342, 344 (not shown). In this embodiment, the sidewall electrodes are arranged as a frustum. By applying appropriate voltages V₁₂ and V₁₃ across the end electrode 312 and respective side electrodes 341, 343, when the resulting fluid contact angles θ₁₂ and θ₁₃ are of appropriate values, a flat fluid meniscus 94 is obtained between liquid A and B. It will be appreciated that, as the sidewalls do not lie parallel to each other, such a flat fluid meniscus 94 will not be obtained when the sum of the fluid contact angles θ₁₂ and θ₁₃ equals 180°. An incoming light beam along optical axis 301 would then be deflected one dimensionally by the meniscus 94 to a direction with a second optical axis 96. The first and second optical axis are related to each other by the deflection angle θ₉₆.

In the embodiments described with reference to FIGS. 3-6B it is assumed that the beam-deflecting element is provided using the electrowetting effect. However, it will be appreciated that other mechanisms can be utilized to provide a beam deflection that can be controllably varied over a continuous range. As mechanical actuators are prone to fatigue, advantageously the beam-deflecting element acts by control of the configuration (e.g. shape or orientation) of a fluid and/or fluid interface.

For instance, a cell having a chamber containing a fluid (i.e. a material capable of flow) comprising a material having two or more indices of refraction can be provided i.e. a birefringent material. A suitable material is a liquid crystal in the nematic phase. By appropriate application of voltage, it is possible to alter the orientation (configuration) of the liquid crystal, and hence control the refractive index of the cell along a predetermined direction.

The angle of refraction experienced by a beam passing from one material to another material depends upon the difference in refractive index of the two materials.

Accordingly, a beam-deflecting element can be formed by providing a layer of liquid crystal, with at least one surface of the layer extending transverse (i.e. across) the radiation beam paths e.g. across the optical axis 19a in the illustrated embodiments. This surface will typically be planar. The planar surface and the optical axis 19a are non-orthogonal i.e. the plane of the surface does not extend perpendicular to the optical axis 19a. Thus, by appropriate application of control voltages to the layer of liquid crystal, the orientation of the director of the liquid crystal (i.e. the preferential axis of the birefringent material) can be altered. Thus, the refractive index of the layer experienced by polarized light incident on the layer along optical axis 19a can be varied. This allows a variation in the angle of deflection experienced by the beam refracting upon the transition between the liquid crystal and the adjacent medium (e.g. air).

FIG. 7 shows one example of a beam-deflecting element 730 incorporating a liquid crystal 732. The liquid crystal is sandwiched between two electrodes 734, 736. By applying a voltage from a voltage source 738 to the two electrodes 734, 736, the orientation of the liquid crystal molecules can be altered.

The refractive index of a liquid crystal in any one direction is dependent upon the orientation of the liquid crystal molecules relative to that direction. Thus, by controlling the voltage applied to the electrodes 734, 736, the refractive index of the liquid crystal 732 along the optical axis (and, in this embodiment, all directions parallel to the optical axis 19a), can be adjusted. In this embodiment, the electrodes extend transverse the optical axis, at a non-orthogonal angle to the optical axis. The electrodes define the outer surfaces of the liquid crystal 732. The electrodes 734, 736 are formed from a transparent material e.g. ITO (Indium Tin Oxide). To provide mechanical support, the electrodes 734, 736 are sandwiched within a rigid transparent material e.g. glass or plastic. Radiation may refract upon entry to and exit from such material, and thus such material will contribute to the overall deviation in optical beam path provided by the beam-deflecting element 730.

The liquid crystal 732 has two surfaces extending transverse the path of incident radiation beams. Each of the surfaces is non-orthogonal to the radiation beam path i.e. in this embodiment, the optical axis 19a. A first surface is bounded by electrode 734, and a second surface is bounded by electrode 736. In this embodiment, the two surfaces are parallel. However, the two surfaces may be at any predetermined angle to the radiation beam path e.g. a first surface can be at an angle A to the radiation beam path, and a second surface can be at an angle-A to the radiation beam path, such that the angle between the two surfaces is 2 A. Thus, a first surface could be used to refract light towards the optical axis 19a, and a second surface utilized to then refract the light along the optical axis 19a by appropriate selection of the refractive index of the adjacent materials (e.g. the electrode).

Alternatively, as in any of the above embodiments, two successive optical elements could be utilized to provide this functionality i.e. a first optical element refracts towards the optical axis, and a second optical element refracts light away from the optical axis. The liquid crystal is birefringent such that the orientation of the molecules can be altered to provide the first refractive index n₁ for a polarization in the direction of the director, and a second refractive index n₂ for a polarization orthogonal to the direction of the director. Thus, by appropriate control of the orientation of the liquid crystal (e.g. by using an appropriate electric field), then any value of refractive index can be provided within the range between n₁ and n₂. Preferably, the refractive index of the material adjacent to the liquid crystal is n₃ where the value of n₃ is between n₁ and n₂ provided the polarization is in the plane spanned by the optical axis and the director. Thus, it will be appreciated that the liquid crystal can be controlled to provide a refractive surface that refracts in a first direction (e.g. with the refractive index of the liquid crystal being greater than n₃), in the second, opposite direction to the first direction (when the refractive index of liquid crystal is less than n₃), and no refractive surface (when the refractive index of the liquid crystal is controlled as to be equal to n₃).

The refractive index experience by a radiation beam traversing a liquid crystal is typically dependent upon the polarization of the radiation beam. In some optical scanning devices, it is possible that different radiation beams have different polarizations. In such instances, it may be preferable that two liquid crystal beam-deflecting elements are provided (or alternatively, a single beam-deflecting element comprising two separate layers of liquid crystal). Each separate layer of liquid crystal may then be controlled to ensure that an appropriate beam deflection is provided to any respective one of the beams of different polarization.

In the above embodiments, the beam-deflecting element has no optical power i.e. it is not arranged to converge (or diverge) the radiation beam, but simply to alter the path of the beam. In other embodiments, the beam-deflecting element may have an optical power e.g. by providing curved surfaces or interfaces. Such an optical power may be suitable for facilitating the focusing of the radiation beam on to the surface of the optical record carrier.

FIG. 8 shows a much more simplified mode of operation of the optical scanning device incorporating a beam deflector element 30a. In the optical scanning device shown in FIG. 8, three radiation sources 7a, 7b, 7c are provided. Each radiation source 7a, 7b, 7c is arranged to provide a separate, different beam of radiation. Each of the beams of radiation is utilized to scan an information layer of a respective optical record carrier. The radiation beam from radiation source 7a is used to scan an information layer 2 of a first type of optical record carrier 3. For ease of explanation, none of the intervening optical components e.g. the beam splitter, collimator, objective lens etc are illustrated.

Each radiation source 7a, 7b, 7c is arranged to provide a separate beam of radiation, substantially parallel to the optical axis 19a of the optical scanning device. In the examples shown in FIGS. 8 and 9, one of the radiation sources 7b is arranged to provide a beam that is aligned with the optical axis 19a. The other radiation sources 7a, 7c are arranged to provide radiation beams that are parallel to, but separated from, the optical axis 19a. This separation has been exaggerated, for ease of explanation. A typical value of the separation of the radiation beams, as emitted from the radiation sources, is less than 200 microns (and often, approximately 100 microns) from the optical axis 19a.

In the mode of operation shown in FIG. 8, the beam-deflecting element 30a is arranged not only to refract the radiation beam towards the optical axis 19a, but also to subsequently refract the radiation beam along the optical axis 19a. A single beam-deflecting element 30a could be utilized to provide such a function e.g. similar to element described in relation to FIG. 4. Alternatively, two separate beam-deflecting elements could be utilized to provide such a function.

It will be appreciated that the beam-deflecting element 30a would also be arranged to align the radiation beam emitted from radiation source 7c with the optical axis 19a, by providing the opposite degree of refraction.

Control of the degree of refraction provide by the beam deflector could be provide in a number of ways. For instance, the beam-deflecting element could be arranged to provide a controlled degree of refraction (including a lack of refraction) depending upon which radiation beam is being utilized by the optical scanning device. Alternatively, active control of the degree of refraction provided by the beam-deflecting element could be provided by measuring the beam landing on the detector. The resulting beam landing signal could be utilized as a servo signal for controlling the degree of refraction provided by the beam-deflecting element (or elements). Beam landing can be detected by measuring the radial error signal when the servo link with the actuator used to control the position of the objective lens system is not closed (i.e. open loop).

A more direct way of measuring beamlanding is provided by the so-called three-spots push-pull method, in which the push-pull signal of the main spot and of the two satellite spots are measured. By utilizing suitably chosen predetermined weighted sums of the three push-pull signals, the radial tracking information and the beamlanding information can be separated. By incorporating a beam-deflecting element utilizing a fluid to provide a variable amount of refraction, multi-radiation beam optical scanning devices can easily be implemented, using beam-deflecting elements to align the beams along the optical axis, and without suffering fatigue, and with relatively low loss of radiation due to the beam-deflecting element.

1. An optical scanning device (1) for scanning an information layer (2) of an optical record carrier (3), the device comprising:
a radiation source (7; 7a, 7b, 7c) for providing at least a first radiation beam along a first optical path, and a second radiation beam along a second, different optical path;
an objective lens system (8), having an optical axis (19a), for converging said radiation beams on said information layer (2); and
a beam deflecting element (30; 130; 230; 330; 730; 30a) arranged to refract at least said second radiation beam towards the optical axis (19a), wherein the beam deflecting element (30; 130; 230; 330; 730; 30a) comprises at least one fluid (A, B, B′; 730) and a controller (112, 141, 143; 241a 243a, 212, 241b, 243b; 341, 343, 312; 734, 736) for varying the configuration of said fluid to controllably vary the amount of refraction provided by the beam-deflector element over a predetermined range.

2. A device as claimed in claim 1, wherein said fluid comprises a birefringent material (732) and the controller (734, 736) is arranged to alter the orientation of the preferential axis of the birefringent material.

3. A device as claimed in claim 2, wherein said birefringent material (732) comprises a liquid crystal, and the controller (734, 736) is arranged to provide an electric field across the liquid crystal (732) for altering the orientation of the liquid crystal.

4. A device as claimed in claim 1, wherein said element comprises a chamber, and said at least one fluid comprises a first, polar fluid (B; B′) and a second, insulative fluid (A), the two fluids being non-miscible and separated along an interface (80; 86, 88; 94), and the controller (112, 141, 143; 241a 243a, 212, 241b, 243b; 341, 343, 312) being arranged to alter the configuration of the interface (80; 86, 88; 94) via the electrowetting effect.

5. A device as claimed in claim 4, wherein the controller (112, 141, 143; 241a 243a, 212, 241b, 243b; 341, 343, 312) is arranged to alter the shape of the interface (80; 86, 88; 94).

6. A device as claimed in claim 4, wherein said controller (112, 141, 143; 241a 243a, 212, 241b, 243b; 341, 343, 312) is arranged to alter the angle of the interface relative to the optical axis.

7. A device as claimed in claim 4, wherein said interface (80; 86, 88; 94) is substantially planar.

8. A device as claimed in claim 1, wherein the controller (112, 141, 143; 241a 243a, 212, 241b, 243b; 341, 343, 312; 734, 736) is arranged to alter the refraction provided by the beam deflecting element (30; 130; 230; 330; 730; 30a) in dependence upon a signal indicative of which radiation beam is being provided by said radiation source (7; 7a, 7b, 7c).

9. A device as claimed in claim 1, further comprising a detector (23) for detecting at least a portion of the radiation beams reflected from the optical record carrier (3), and wherein the controller (112, 141, 143; 241a 243a, 212, 241b, 243b; 341, 343, 312; 734, 736) is arranged to alter the refraction provided by the beam deflecting element (30; 130; 230; 330; 730; 30a) in dependence upon the signal detected by said detector.

10. A device as claimed in claim 1, wherein said device comprises a detector (23) for detecting at least a portion of the radiation beams reflected from the optical record carrier (3); and
a beam splitter (9) for transmitting incident radiation beams received from the radiation source towards the optical record carrier (3), and for transmitting beams reflected from the optical record carrier towards the detector (23); and
wherein the beam deflecting element (30; 130; 230; 330; 730; 30a) is positioned between the radiation source (7; 7a, 7b, 7c) and the beam splitter (9).

11. A device as claimed in claim 1, further comprising an astigmatism correction plate (32) for cancelling out astigmatism introduced into the beam by the beam deflecting element (30).

12. A device as claimed in claim 1, wherein the beam deflecting element (30; 130; 230; 330; 730; 30a) is arranged to further refract the second radiation beam so as to direct the optical path of the second radiation beam along the optical axis (19a).

13. A device as claimed in claim 1, wherein the radiation source (7; 7c)is arranged to provide a third radiation beam along a third optical path different from said first and second optical paths, the beam deflecting element (30; 130; 230; 330; 730; 30a) being further suitable for refracting said third radiation beam towards the optical axis (19a).

14. A method of manufacture of an optical scanning device for scanning an information layer of an optical record carrier, the method comprising:
providing a radiation source (7; 7a, 7b, 7c) for providing at least a first radiation beam along a first optical path, and a second radiation beam along a second, different optical path;
providing an objective lens system (8), having an optical axis (19a), for converging said radiation beams on said information layer (2); and
providing a beam deflecting element (30; 130; 230; 330; 730; 30a) arranged to refract at least said second radiation beam towards the optical axis (19a), wherein the beam deflecting element (30; 130; 230; 330; 730; 30a) comprises at least one fluid (A, B, B′; 730) and a controller (112, 141, 143; 241a 243a, 212, 241b, 243b; 341, 343, 312; 734, 736) for varying the configuration of said fluid to controllably vary the amount of refraction provided by the beam-deflector element over a predetermined range.

15. A method of operation of an optical scanning device for scanning an information layer of an optical record carrier, the device comprising a radiation source (7; 7a, 7b, 7c) for providing at least a first radiation beam along a first optical path, and a second radiation beam along a second, different optical path; an objective lens system (8), having an optical axis (19a), for converging said radiation beams on said information layer (2); and a beam deflecting element (30; 130; 230; 330; 730; 30a) arranged to refract at least said second radiation beam towards the optical axis (19a), wherein the beam deflecting element (30; 130; 230; 330; 730; 30a) comprises at least one fluid (A, B, B′; 730) and a controller (112, 141, 143; 241a 243a, 212, 241b, 243b; 341, 343, 312; 734, 736) for varying the configuration of said fluid to controllably vary the amount of refraction provided by the beam-deflector element;
wherein the method of operation comprises varying the refraction provided by the beam deflecting element over a predetermined range in dependence upon the radiation beam being provided by the radiation source.
